(19) United States
(12) Patent Application Publication
(10) Pub. No.: US 2015/0172628 A1
(43) Pub. Date: Jun. 18, 2015

(54) Altering Automatically-Generated Three-Dimensional Models Using Photogrammetry

(71) Applicants: Brian Gammon BROWN, Boulder, CO (US); Tilman Reinhardt, Woodside, CA (US); Zhe Fan, Boulder, CO (US); Scott Shattuck, Boulder, CO (US)

(72) Inventors: Brian Gammon BROWN, Boulder, CO (US); Tilman Reinhardt, Woodside, CA (US); Zhe Fan, Boulder, CO (US); Scott Shattuck, Boulder, CO (US)

(73) Assignee: Google Inc., Mountain View, CA (US)

(21) Appl. No.: 13/174,493

(22) Filed: Jun. 30, 2011

(51) Int. Cl. H04N 13/02; G06T 17/10; G06K 9/00

(52) U.S. Cl. CPC H04N 13/0207; G06T 17/10

(57) ABSTRACT

Embodiments enable alteration of automatically-generated three-dimensional models using photogrammetry. In an embodiment, a method creates a three-dimensional model using a two-dimensional photographic image. An automatically generated three-dimensional model geocoded within a field of view of a camera that took the two-dimensional photographic image is received. A perspective of the camera that took the photographic image is represented by a set of camera parameters for the first two-dimensional photographic image. A user input constraint indicating that a feature of the automatically generated three-dimensional model corresponds to a position on two-dimensional photographic image is also received. In response to the user input constraint, the three-dimensional model is altered, using photogrammetry, according to the user input constraint and the set of camera parameters.

### BACKGROUND

1. Field of the Invention

This field is generally related to three-dimensional modeling.

2. Related Art

Three-dimensional modeling tools and other computer-aided design (CAD) tools enable users to define three-dimensional models, such as a three-dimensional model of a building. Photographic images of the building may be available from, for example, satellite, aerial, vehicle-mounted street-view and user cameras. The photographic images of the building may be texture mapped to the three-dimensional model to create a more realistic rendering of the building.

In addition to tools that allow a user to specify a three-dimensional model, other methods exist that automatically generate three dimensional models. For example, LIDAR (Light Detection and Ranging) data representing buildings may be collected over a wide area from aircraft. The LIDAR data may include a cloud of points, and three-dimensional shapes may be fitted to the cloud of points. While this automatic generation of a three-dimensional model may not require as much work by a user, it may not accurately represent the building.

### BRIEF SUMMARY

Embodiments enable alteration of automatically-generated three-dimensional models using photogrammetry. In an embodiment, a method creates a three-dimensional model using a two-dimensional photographic image. An automatically generated three-dimensional model geocoded within a field of view of a camera that took the two-dimensional photographic image is received. A perspective of the camera that took the photographic image is represented by a set of camera parameters for the first two-dimensional photographic image. A user input constraint indicating that a feature of the automatically generated three-dimensional model corresponds to a position on two-dimensional photographic image is also received. In response to the user input constraint, the three-dimensional model is altered, using photogrammetry, such that the feature of the three-dimensional model appears at the position on the two-dimensional photographic image when rendered from the perspective represented by the camera parameters.

Systems and computer program products for altering automatically-generated three-dimensional models using photogrammetry are also described.

By enabling alteration of automatically-generated three-dimensional models using photogrammetry, embodiments may enable a user to create three-dimensional models more quickly and easily.

Further embodiments, features, and advantages of the invention, as well as the structure and operation of the various embodiments of the invention are described in detail below with reference to accompanying drawings.

### BRIEF DESCRIPTION OF THE FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1A is a diagram illustrating detection of a point cloud representing a street scene.

FIG. 1B is a diagram illustrating a three-dimensional model including three-dimensional shapes determined according to the point cloud of FIG. 1A.

FIG. 2A is a diagram illustrating a user interface that includes a photograph of the street scene and a wireframe of the three-dimensional model of FIG. 1B overlaid from the perspective of the photograph.

FIG. 2B is a diagram illustrating a user interface that includes a photograph of the street scene taken from a different perspective and a wireframe of the three-dimensional model of FIG. 1B overlaid from the different perspective.

FIG. 3 is a diagram illustrating alteration of a three-dimensional model using photogrammetry.

FIG. 4 is a flowchart illustrating a method for altering an automatically-generated three-dimensional models using photogrammetry.

FIG. 5 is a diagram illustrating a system for altering an automatically-generated three-dimensional models using photogrammetry.

The drawing in which an element first appears is typically indicated by the leftmost digit or digits in the corresponding reference number. In the drawings, like reference numbers may indicate identical or functionally similar elements.

### DETAILED DESCRIPTION OF EMBODIMENTS

Embodiments enable alteration of automatically-generated three-dimensional models using photogrammetry. In an embodiment, a three-dimensional model may be automatically generated from LIDAR data within the field of view of a photograph. The user may input a constraint mapping a position on the three-dimensional model to a position on the photograph. Using information about the perspective of the photograph, the three-dimensional model may be updated according to the user constraint. Moreover, a user may make additional modifications to the three-dimensional model. For example, the user can remove unwanted shapes, including artifacts caused by the automatic generation process. Also, the user can add additional primitive shapes and align them to the positions in photographs to further specify the three-dimensional model.

In the detailed description of embodiments that follows, references to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

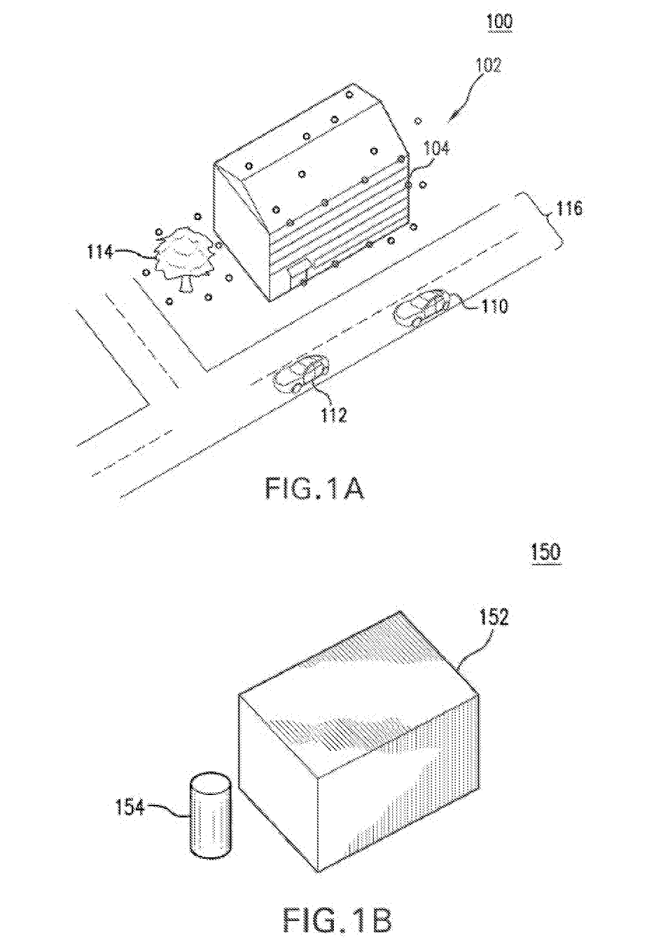

FIG. 1A is a diagram 100 illustrating detection of a point cloud representing a street scene. Diagram 100 illustrates a three-dimensional space, including a building 104 and a tree 114. In an example, LIDAR data representing building 104 and tree 114 may be sampled from an overhead aircraft. In a further example, the LIDAR data may be sampled a vehicle moving along a street 116. The LIDAR data may include a cloud of points 102. Each point in cloud of points 102 may be a position in three-dimensional space detected by a LIDAR sensor.

In another embodiment, cloud of points 102 may be generated without use of LIDAR sensors, such as using a structure-from-motion algorithm. For example, a vehicle may take photographs of building 104 and tree 114 as it moves along street 116. In particular, the vehicle may take photographs at positions 110 and 112. Features from the respective photographs may be detected and matched with one another. As a result of the detection and matching, pairs of corresponding two-dimensional points on the photographs may be identified. For each pair of two-dimensional points, a point in three-dimensional space may be calculated using stereo triangulation. In this way, cloud of points 102 may also be determined using photographic images.

Once cloud of points 102 is determined, a three-dimensional model may be derived. For example, three dimensional shapes may be fit into the cloud of points 102 using search and optimization techniques. In one example, a shape may be selected from a plurality of primitive shapes. The plurality of primitive shapes may include a box, gable, hip, pyramid, top-flat pyramid, cylinder or ramp. With a shape selected, geometric parameters defining aspects of the shape may be optimized. The geometric parameters may include, for example, a position of an origin point (e.g., x, y, and z coordinates), a scale (e.g., height and width), an orientation (e.g., pan, tilt, and roll). The geometric parameters may be optimized using a best-fit or regression analysis algorithm, such as least-squares, or an adaptive optimization algorithm. Examples of adaptive optimization algorithms include, but are not limited to, a hill-climbing algorithm, a stochastic hill-climbing algorithm, an A-star algorithm, and a genetic algorithm. Different geometric shapes may be tried, and a shape having the best fit (as determined by a cost function) may be selected. An example of shapes that may be determined from cloud of points 102 is illustrated in FIG. 1B.

FIG. 1B is a diagram 150 illustrating a three-dimensional model including three-dimensional shapes determined according to cloud of points 102. The three-dimensional model includes a box 152 and a cylinder 154. The box 152 approximates the points corresponding to building 104, and cylinder 154 may roughly correspond to tree 114. Notably, features from both building 104 and tree 114 are missing from the automatically generated shapes. Inaccuracies in the automatically generated three dimensional model may result from inaccuracy of the LIDAR sensors or from limitations in the automatic generation algorithm. For example, the automatic generation search and optimization process may fail to identify the gable on the roof on building 104. Also, none of the primitive shapes may closely resemble tree 114, so the automatic generation may make a “best guess” at the shape. In the example of diagram 150, the automatic generation algorithm roughly models tree 114 as cylinder 154.

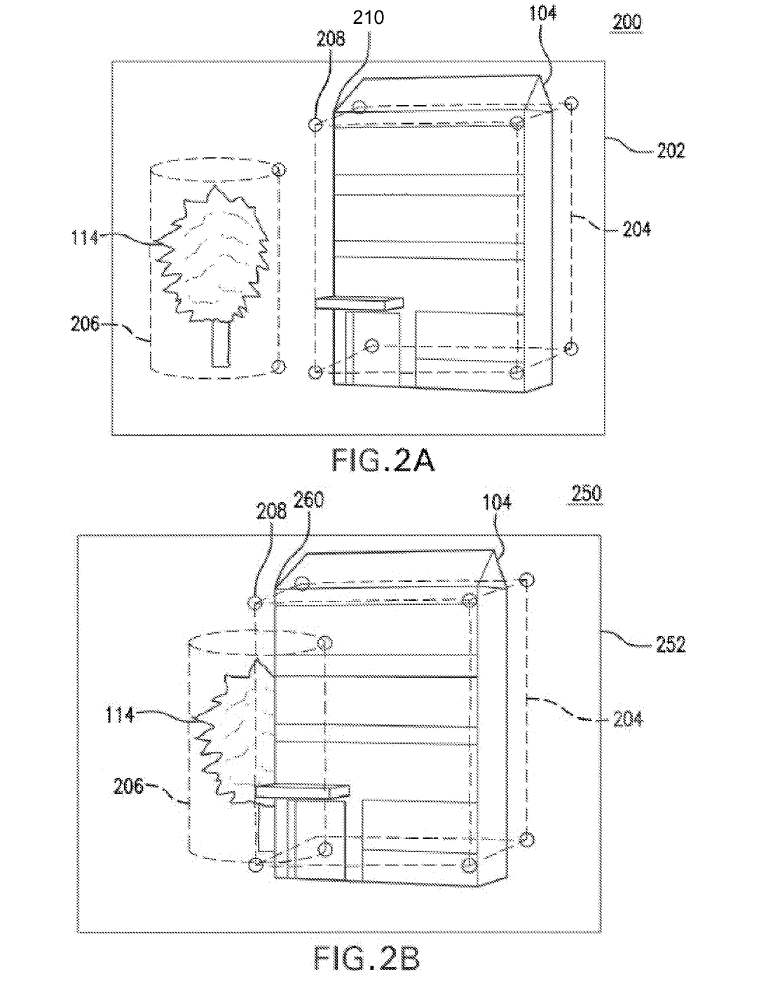

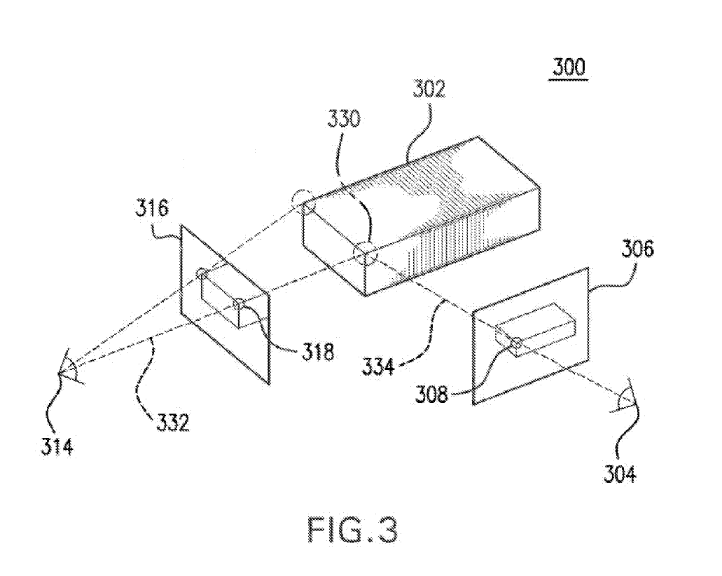

Once a three-dimensional model has been created, a user alters the model to correct for inaccuracies based on photographic images of the scene. To constrain the model to positions on the photographic images, a user may use an interface as illustrated in FIGS. 2A-B. From the user-inputted constraints, the three-dimensional model is updated using photogrammetry as illustrated in FIG. 3.

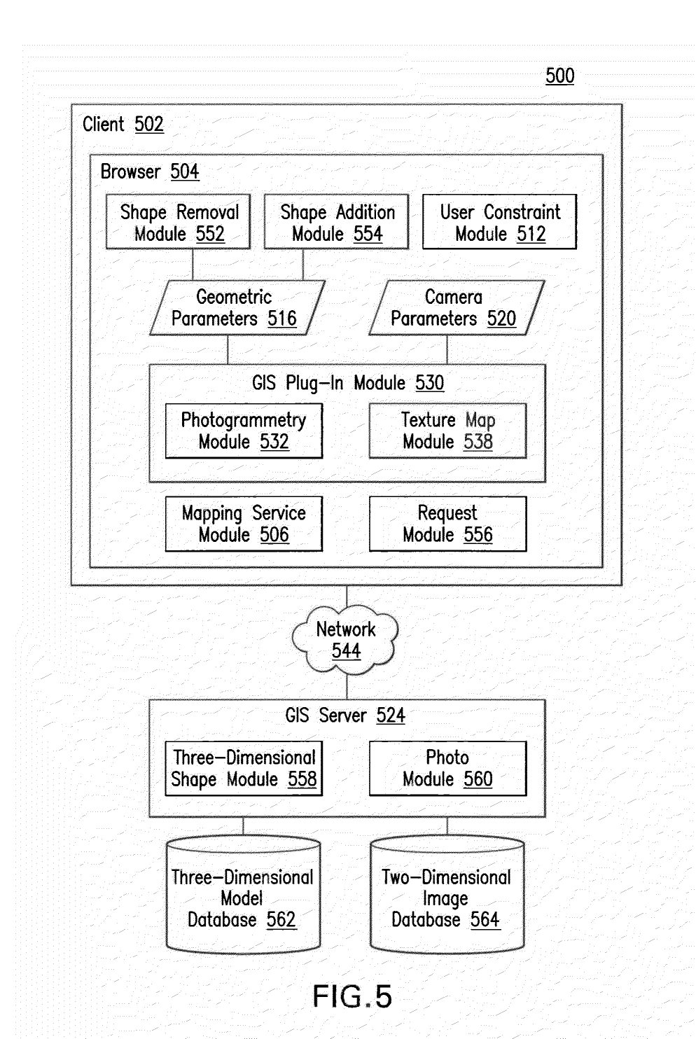

FIG. 2A is a diagram illustrating a user interface 200 that includes a photograph 202 of the street scene and a wireframe of the three-dimensional model of FIG. 1B overlaid from the perspective of the photograph. Similarly, FIG. 2B is a diagram illustrating a user interface 250 that includes a photograph 252 of the street scene taken from a different perspective and a wireframe of the three-dimensional model of FIG. 1B overlaid from the different perspective. As described below with respect to FIG. 5, user interfaces 200 and 250 may, in an embodiment, be a web based user interface. In the embodiment, a server may serve to a client data, such as Hypertext markup language (HTML) data, Javascript, or animation (e.g. FLASH) data, specifying user interfaces 200 and 250. Using that data, the client may render and display user interface 200 and 250 to a user.

Each of photographic images 202 and 252 show building 104 and tree 114 from a different perspective. Each of photographic images may be an aerial or satellite image and may have oblique and nadir images. Further, one or more of the photographic images may be captured from street level, such as a portion of a panoramic image captured from a vehicle in motion. Each of user interface 200 and 250 may be displayed with an indication (such as a colored outline) indicating whether a user constraint has been received for the image.

In each of user interface 200 and 250, the automatically generated three-dimensional model may be displayed. The three-dimensional model may be displayed, for example, as a wireframe structure so as to avoid obscuring the photographic images. Each shape in the three dimensional model may be represented by a separate wireframe. For example, in user interfaces 200 and 250, wireframe 206 represents cylinder 154, and wireframe 204 represents box 152. The wireframes may be rendered onto the photographic images from the perspective of the cameras that took the images.

By selecting points, such as a point 208, on the wireframe representation of the three-dimensional model, a user may constrain the three-dimensional model to the images. More specifically, a user may indicate that a position on the three-dimensional model corresponds to a position on the photographic images in interfaces 200 and 250. By inputting constraints for the images in both interface 200 and interface 250, a user can specify where the three-dimensional model appears in each of the images. In the example in FIGS. 2A and 2B, a user can indicate that point 208 is located at position 210 on photograph 202 and at position 260 on photograph 252. Based on the user specifications, the geometry of the three-dimensional model may be determined using a photogrammetry algorithm as illustrated in FIG. 3. In this way, a user may alter the automatically generated three-dimensional model to model building 104 using images of the building.

In addition to altering previously generated three-dimensional shapes, interfaces 200 and 250 may enable a user to remove an automatically generated shape or to add an additional shape. A user may be able to remove a shape, for example, by right-click on the wireframe representation of the shape and selecting a remove option from a menu. In the example in FIGS. 2A and 2B, a user may want to remove the cylinder representing the tree, because it may be a highly inaccurate representation and the user may only want to model the buildings.

Similarly, a user can add a new shape by selecting the type of shape (box, gable, hip, pyramid, top-flat pyramid, cylinder or ramp) from a menu (not shown). Once the shape is added, a user altered by inputting and moving constraints mapping points (such as vertices) on the three-dimensional model to positions on the two-dimensional images. In the example in FIGS. 2A and 2B, a user may want to add a gable representing the roof of building 104.

FIG. 3 shows a diagram 300 illustrating alteration of a three-dimensional model 302 using photogrammetry. Diagram 300 shows a three-dimensional model 302 and multiple photographic images 316 and 306 of a building. Images 316 and 306 were captured from cameras having different perspectives, as illustrated by cameras 314 and 304. As mentioned above, a user may input constraints on images 316 and 306, such as constraints 318 and 308, and those constraints may be used to determine the geometry of three-dimensional model 200. The geometry of three-dimensional model 302 may be specified by a set of geometric parameters, representing, for example, a position of an origin point (e.g., x, y, and z coordinates), a scale (e.g., height and width), an orientation (e.g., pan, tilt, and roll). Depending on a shape of three-dimensional model 302 (e.g., box, gable, hip, pyramid, top-flat pyramid, cylinder or ramp) additional geometric parameters may be needed. For example, to specify the geometry of a gable, the angle of the gable's slopes or a position of the gable's tip may be included in the geometric parameters.

To determine the geometry of three-dimensional model 302, the user constraints from the images may be used to determine rays in three-dimensional space and the rays are used to determine the geometry. In diagram 300, a ray 332 may be determined based on user constraint 318, and a ray 334 may be determined based on a user constraint 308. Rays 332 and 334 are constructed based on parameters associated with cameras 314 and 304 respectively. For example, ray 332 may be extended from a focal point or entrance pupil of camera 314 through a point corresponding to user constraint 318 at a focal length distance from the focal point of camera 314. Similarly, ray 334 may be extended from a focal point or entrance pupil of camera 304 through a point corresponding to user constraint 208 at a focal length distance from the focal point of camera 304. Using rays 332 and 334, a position 330 on three-dimensional model 302 may be determined. This process is known as photogrammetry. In this way, the geometry of three-dimensional model 302 may be determined based on user constraints 318 and 308, and parameters representing cameras 314 and 304.

However, the parameters representing cameras 314 and 304 may not be accurate. In an embodiment, the camera parameters may include a position, orientation (e.g., pan, tilt, and roll), angle, focal length, prism point, and a distortion factor of each of cameras 314 and 304. In an example, photographic images 316 and 306 may have been taken from satellites, vehicles, or airplanes, and the camera position and orientation may not be completely accurate. Alternatively, one or both of photographic images 316 and 306 may have been taken by a user with only a general idea of where her camera was positioned when it took the photo.

In cases where the camera parameters are inaccurate, a photogrammetry algorithm may need to solve both the camera parameters representing the cameras that took the photographic images and geometric parameters representing the three-dimensional model. This may represent a large and complex non-linear optimization problem.

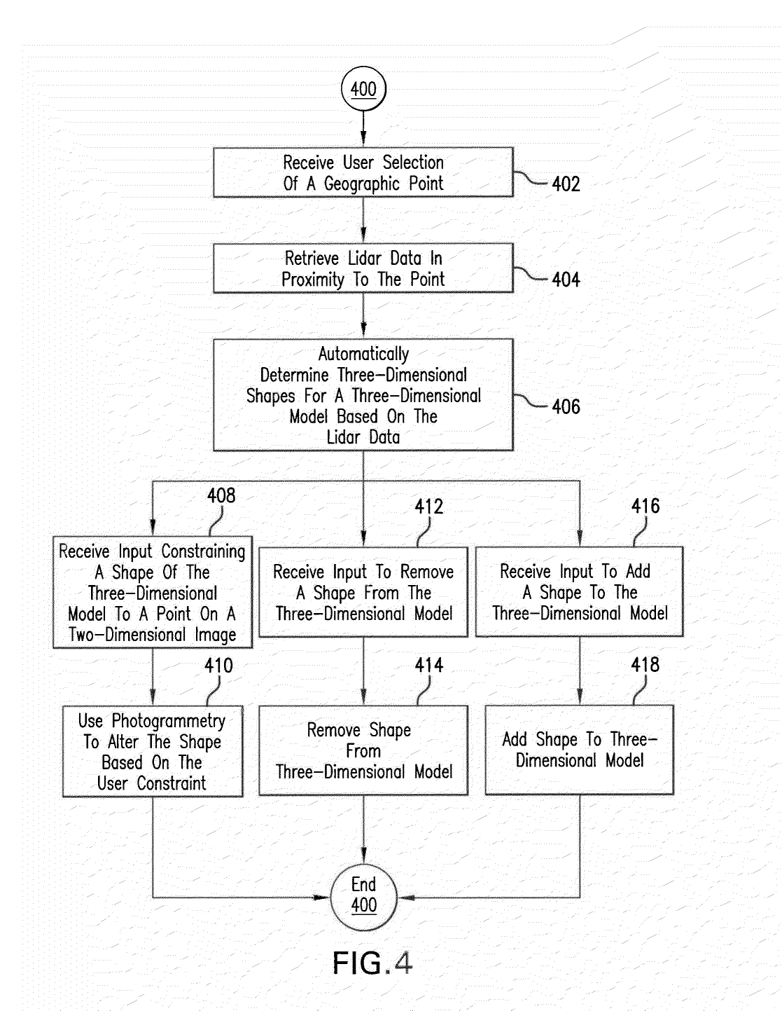

FIG. 4 is a flowchart illustrating a method 400 for altering an automatically-generated three-dimensional model using photogrammetry.

Method 400 begins at a step 402 when a user selection of a geographic point is received. The user may indicate a desire to create a three dimensional model at a particular location. To indicate the desire, the user may, for example, right click on the particular location on the map. Is this way, an input is received selecting a position on a map. In one embodiment, the position may be included in a request sent to a server to retrieve two-dimensional photographic images and automatically generated three-dimensional model data geocoded in proximity to the position.

At step 404, LIDAR data in proximity to the geographic point is retrieved and, at step 406, three-dimensional shapes representing a three-dimensional model are automatically determined based on the LIDAR data. In one embodiment, steps 404 and 406 occur on a server in response to a request with the received geographic point. In another embodiment, the three-dimensional shapes may be generated in advance of any request to create a three-dimensional model.

The retrieved LIDAR data may include a cloud of points in a three-dimensional space. In other embodiments, the cloud of points may be generated not from LIDAR sensors, but instead using structure-from-motion. The three-dimensional shapes are generated automatically as described above with respect to FIGS. 1A-B.

At step 408, an input that constrains a shape of the three-dimensional model to a point on a two-dimensional image is received. The two-dimensional image has a field of view that encompasses at least a portion of the automatically generated shapes. The user constraint may be inputted using an interface as described above with respect to FIGS. 2A-B. In response to the input, the shape is altered using photogrammetry to comply with the constraint at step 410. The photogrammetry may operate as described above with respect to FIG. 3.

At step 412, an input is received to remove a shape of the three-dimensional model to a point on a two-dimensional image. In response to the input, the shape is removed at step 414.

At step 416, an input is received to add a shape to the three-dimensional model. The input may designate the type of shape to be added. In response to the input, the shape is added at step 418.

FIG. 5 is a diagram illustrating a system 500 for altering an automatically-generated three-dimensional model using photogrammetry. System 500 may operate as described above with respect to FIGS. 1-4. System 500 may include a client 502 coupled to a GIS server 524 via one or more networks 544, such as the Internet. Client 502 includes a browser 504. Browser 504 includes a user constraint module 512, shape addition module 554, shape removal module 552, mapping service module 506 request module 556, GIS plug-in module 530, geometric parameters 516 and camera parameters 520. GIS plug-in module 530 includes a photogrammetry module 532, and a texture map module 538. Each of these components is described below. GIS server 524 includes a three-dimensional shape model 558 and a photo module 560, and is coupled to a three-dimensional model database 562 and a two-dimensional image database 564.

In embodiments, browser 504 may be a CHROME, FIREFOX, SAFARI, or INTERNET EXPLORER browser. The components of browser 504 may be downloaded from a server, such as a web server, and run with browser 504. For example, the components of browser 504 may be Hypertext Markup Language (HTML), JavaScript, or a plug-in, perhaps running native code. GIS plug-in module 530 may be a browser plug-in implementing a pre-specified interface and compiled into native code.

In general, system 500 may operate as follows. Using mapping service module 506, a user may indicate a desire to create a three-dimensional model at a specified location. Request module 556 may send the location in a request across network 334 to GIS server 524. At GIS server 524, three-dimensional shape module 558 retrieves nearby shapes from three-dimensional model database 562, and two-dimensional image database two-dimensional image database 564. In response to the request, GIS server sends the retrieved shapes and images to client 502. Information describing the geometry of the retrieved shapes is stored in geometric parameters 516, and information describing cameras that took the retrieved images is stored in camera parameters 520. A user modifies the shapes by constraining them to images using user constraint module 512. Once a user maps position on a three-dimensional shape to a position on a two dimensional module, photogrammetry module updates the shape geometry accordingly.

Mapping service module 506 displays a visual representation of a map, e.g., as a viewport into a grid of map tiles. Mapping service module 506 is implemented using a combination of markup and scripting elements, e.g., using HTML and Javascript. As the viewport is moved, mapping service module 506 requests additional map tiles from server(s) 544, assuming the requested map tiles have not already been cached in local cache memory. A user is able to identify a geographic location on the map by selecting the location. In an embodiment, a user may select a location

Upon receipt of a user selection indicating a particular region at which to create a three-dimensional model, request module 556 sends a request to GIS server 524. The request may specify the location and query GIS server 524 for automatically generated three-dimensional model data and images in the region. In an embodiment, the field of view of the images may include at least a portion of the automatically generated three-dimensional models.

GIS server 524 receives the request from request module 556. GIS server 524 may include a web server. A web server is a software component that responds to a hypertext transfer protocol (HTTP) request with an HTTP reply. The web server may serve content such as hypertext markup language (HTML), extendable markup language (XML), documents, videos, images, multimedia features, or any combination thereof. This example is strictly illustrative and does not limit the present invention. GIS server includes a photo module 560 and a three-dimensional shape module 558.

Three-dimensional shape module 558 retrieves automatically generated three-dimensional shapes from three-dimensional model database 562. The retrieved shapes are geocoded in proximity to the location selected by a user. In an example, the shapes may be geocoded in a pre-specified perimeter of the location selected by a user. In one embodiment, three-dimensional shape module 558 may automatically generate the three-dimensional shapes in advance from a LIDAR data and stored in three-dimensional model database 562. In another embodiment, three-dimensional shape module 558 may automatically generate the three-dimensional shapes in response to the request.

Photo module 560 retrieves two-dimensional photographic images from two-dimensional image database 564. The two-dimensional photographic images are taken of an area occupied at least in part by the retrieved automatically-generated shapes. Photo module 560 also retrieves camera information describing the location and orientation of the cameras that took the two-dimensional photographic images

Once photo module 560 retrieves two-dimensional photographic images and three-dimensional shape module 558 retrieves automatically generated three-dimensional shapes, GIS server 524 sends the shapes, images, and camera information back to client 502.

Request module 556 receives the shapes, images, and camera information from GIS server 524. Request module 556 stores information representing the shapes as geometric parameters 516 and information representing the cameras that took the images as camera parameters 520. The photographic images received by request module 556 may be displayed by the user constraint module 512.

User constraint module 512 may display an interface as illustrated in examples in 2A-B. As illustrated in those figures, the interface may display the photographic images overlaid with the three-dimensional model described by geometric parameters 516. The three-dimensional model may be presented as a wireframe structure rendered from the perspective of the cameras described by camera parameters 520.

User constraint module 512 may receive at least one constraint, input by a user, for a two-dimensional photographic images from the set of two-dimensional photographic images received from GIS server 524. Each constraint indicates that a position on the two-dimensional photographic image corresponds to a position on the three-dimensional model. In an embodiment, a user constraint module may receive a first user input specifying a first position on a first photographic image, and a second user input specifying a second position on a second photographic image. The second user input may further indicate that a feature located at the second position on the second photographic image corresponds to a feature located at the first position on the first photographic image.

Photogrammetry module 532 may modify geometric parameters 516 and camera parameters 520 according to the user constraints received by user constraint module 512. Geometric parameters 516 and camera parameters 520 may be used to texture map the photographic images received from GIS server 524 to the three-dimensional model. As mentioned above, geometric parameters 516 may include parameters representing various shapes for a three-dimensional model.

Once the three-dimensional model is determined using the photographic images, texture map module 538 may texture map the three-dimensional model using the same images used to create the model. Texture map module 538 may texture map the image to a surface of a three-dimensional model. Texture map module 538 may use back casting to texture map the polygon face. Though in some embodiments, texture map module 538 may leave the face untextured and render the face in a solid color (e.g., black). Further, texture map module 538 may provide an option to a user to add an additional constraint mapping a position on a back-up photographic image to a position on the three-dimensional model. By texture mapping the same images to the three-dimensional model that were used to construct the three-dimensional model, texture map module 538 may enable more efficient modeling and more precise texture mapping.

Each of client 502 and GIS server 524 may be implemented on any computing device. Such computing device can include, but is not limited to, a personal computer, mobile device such as a mobile phone, workstation, embedded system, game console, television, set-top box, or any other computing device. Further, a computing device can include, but is not limited to, a device having a processor and memory for executing and storing instructions. Software may include one or more applications and an operating system. Hardware can include, but is not limited to, a general purpose processor, graphics processor, memory and graphical user interface display. The computing device may also have multiple processors and multiple shared or separate memory components. For example, the computing device may be a clustered computing environment or server farm.

Geometric parameters 516 may be further modified using shape removal module 552 and shape addition module 554. In response to a user input, shape removal module 552 removes a shape from geometric parameters 516, and, also in response to a user input, shape addition module 554 adds a shape to geometric parameters 516.

Each of browser 504, user constraint module 512, GIS plug-in module 530, photogrammetry module 532, shape removal module 552, shape addition module 554, request module 556, mapping service module 506, three-dimensional shape module 558, photo module 560, and texture map module 538 may be implemented in hardware, software, firmware, or any combination thereof.

Each of geometric parameters 516, camera parameters 520, three-dimensional model database 562, and two-dimensional image database 564 may be stored in any type of structured memory, including a persistent memory. In examples, each database may be implemented as a relational database.

The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

1. A computer-implemented method for creating a three-dimensional model, comprising:
receiving, by one or more computing devices, an automatically generated three-dimensional model geocoded within a first field of view of a first camera that tools a first two-dimensional photographic image and geocoded within a second field of view of a second camera that took a second two-dimensional photographic image, wherein a first perspective of the first camera that took the first two-dimensional photographic image is represented by a first set of camera parameters for the first two-dimensional photographic image and a second perspective of the second camera that took the second two-dimensional photographic image is represented by a second set of camera parameters for the second two-dimensional photographic image, wherein the first set of camera parameters includes at least a first focal length associated with the first two-dimensional photographic image and a first capture location at which the first two-dimensional photographic image was captured, wherein the second set of camera parameters includes at least a second focal length associated with the second two-dimensional photographic image and a second capture location at which the second two-dimensional photographic image was captured, wherein the first capture location and the second capture location comprise locations in three-dimensional space, and wherein each of the one or more computing devices comprises one or more processors;
receiving, by the one or more computing devices, a first user input constraint indicating that a feature of the automatically generated three-dimensional model corresponds to a first position on the first two-dimensional photographic image;
receiving, by the one or more computing devices, a second user input constraint indicating that the feature of the automatically generated three-dimensional model corresponds to a second position on the second two-dimensional photographic image;
determining, by the one or more computing devices, a first point in three-dimensional space by extending a first ray from the first capture location through the first position on the first two-dimensional photographic image as indicated by the first user input constraint, the first ray having the first focal length;
determining, by the one or more computing devices, a second point in three-dimensional space by extending a second ray from the second capture location through the second position on the second two-dimensional photographic image as indicated by the second user input constraint, the second ray having the second focal length; and
when the first point in three-dimensional space and the second point in three-dimensional space are located at a same position, altering the automatically generated three-dimensional model such that the feature is located at the same position in three-dimensional space.

2. The method of claim 1, wherein receiving the automatically generated three-dimensional model comprises receiving a plurality of three-dimensional shapes included in the three-dimensional model, and the method further comprising:
receiving, by the one or more computing devices, an input from a user, the input selecting a shape from the plurality of three-dimensional shapes to remove from the three-dimensional model;
in response to the input, removing, by the one or more computing devices, the selected shape from the three-dimensional model.

3. The method of claim 1, further comprising:
receiving, by the one or more computing devices, an input from a user selecting a three-dimensional shape to add to the three-dimensional model; and
in response to the input, adding, by the one or more computing devices, the selected shape from the three-dimensional model.

4. The method of claim 1, wherein the three-dimensional model includes a plurality of three dimensional shapes and is automatically generated from a cloud of points in a three dimensional space.

5. The method of claim 4, wherein each point in the cloud of points is determined using LIDAR.

6. The method of claim 4, wherein each point in the cloud of points is determined using structure-from-motion.

7. The method of claim 1, further comprising:
receiving an input from a user selecting a position on a map;
sending a request to a server with the selected position; and
receiving a response to the request from the server, the response including the first and second two-dimensional photographic images and the automatically generated three-dimensional mode, wherein the three-dimensional model is geocoded in proximity to the position on the map.

8. (canceled)

9. A system for creating a three-dimensional model, the system comprising:
a request module that receives an automatically generated three-dimensional model geocoded within a first field of view of a first camera that took a first two-dimensional photographic image and geocoded within a second field of view of a second camera that took a second two-dimensional photographic image,
wherein a first perspective of the first camera that took the first photographic image is represented by a first set of camera parameters for the first two-dimensional photographic image, and wherein a second perspective of the second camera that took the second photographic image is represented by a second set of camera parameters for the second two-dimensional photographic image;
wherein the first set of camera parameters comprises at least a first focal length and a first capture location at which the first two-dimensional photographic image was captured and the second set of camera parameters comprises at least a second focal length and a second capture location at which the second two-dimensional photographic image was captured, and wherein the first capture location and the second capture location comprise locations in three-dimensional space;
a user constraint module that receives a first user input constraint indicating that a feature of the automatically generated three-dimensional model corresponds to a first position on the first two-dimensional photographic image and receive a second user input constraint indicating that the feature of the automatically generated three-dimensional model corresponds to a second position on the second two-dimensional photographic image; and
a photogrammetry module that, in response to the first and second user input constraints:
determines a first point in three-dimensional space by extending a first ray from the first capture location through the first position on the first two-dimensional photographic image as indicated by the first user input constraint, the first ray having the first focal length;
determines a second point in three-dimensional space by extending a second ray from the second capture location through the second position on the second two-dimensional photographic image as indicated by the second user input constraint, the second ray having the second focal length; and
when the first point in three-dimensional space and the second point in three-dimensional space are located at a same position, alters the automatically generated three-dimensional model such that the feature is located at the same position in three-dimensional space.

10. The system of claim 9, wherein the three-dimensional model includes a plurality of three-dimensional shapes, and further comprising:
a shape removal module that receives an input from a user, the input selecting a shape from the plurality of three-dimensional shapes to remove from the three-dimensional model and, in response to the input, removes the selected shape from the three-dimensional model.

11. The system of claim 9, further comprising:
a shape addition module that receives an input from a user selecting a three-dimensional shape to add to the three-dimensional model and, in response to the input, adds the selected shape from the three-dimensional model.

12. The system of claim 9, wherein the three-dimensional model includes a plurality of three dimensional shapes and is automatically generated from a cloud of points in a three dimensional space.

13. The system of claim 12, wherein each point in the cloud of points is determined using LIDAR.

14. The system of claim 12, wherein each point in the cloud of points is determined using structure-from-motion.

15. The system of claim 9, further comprising:
a mapping service module that receives an input from a user selecting a position on a map,
wherein the request module sends a request to a server with the selected position and receives a response to the request from the server, the response including the first and second two-dimensional photographic images and the automatically generated three-dimensional model, wherein the three dimensional model is geocoded in proximity to the position on the map.

16. (canceled)

17. A non-transitory computer readable storage medium having instructions tangibly stored thereon that, when executed by a computing device, cause the computing device to execute a method for creating a three-dimensional model, the method comprising:
receiving an automatically generated three-dimensional model geocoded within a first field of view of a first camera that took a first two-dimensional photographic image and geocoded within a second field of view of a second camera that took a second two-dimensional photographic image, wherein a first perspective of the first camera that took the first two-dimensional photographic image is represented by a first set of camera parameters for the first two-dimensional photographic image and a second perspective of the second camera that took the second two-dimensional photographic image is represented by a second set of camera parameters for the second two-dimensional photographic image, wherein the first set of camera parameters includes at least a first focal length associated with the first two-dimensional photographic image and a first capture location at which the first two-dimensional photographic image was captured, wherein the second set of camera parameters includes at least a second focal length associated with the second two-dimensional photographic image and a second capture location at which the second two-dimensional photographic image was captured, and wherein the first capture location and the second capture location comprise locations in three-dimensional space;
receiving a first user input constraint indicating that a feature of the automatically generated three-dimensional model corresponds to a first position on the first two-dimensional photographic image;
receiving, by the one or more computing devices, a second user input constraint indicating that the feature of the automatically generated three-dimensional model corresponds to a second position on the second two-dimensional photographic image;
determining, by the one or more computing devices, a first point in three-dimensional space by extending a first ray from the first capture location through the first position on the first two-dimensional photographic image as indicated by the first user input constraint, the first ray having the first focal length;
determining, by the one or more computing devices, a second point in three-dimensional space by extending a second ray from the second capture location through the second position on the second two-dimensional photographic image as indicated by the second user input constraint, the second ray having the second focal length; and
when the first point in three-dimensional space and the second point in three-dimensional space are located at a same position, altering the automatically generated three-dimensional model such that the feature is located at the same position in three-dimensional space.

18. The non-transitory computer readable storage medium of claim 17, wherein receiving the automatically generated three-dimensional model comprises receiving a plurality of three-dimensional shapes included in the three-dimensional model, and the method further comprising:
receiving an input from a user the input selecting a shape from the plurality of three-dimensional shapes to remove from the three-dimensional model;
in response to the input, removing the selected shape from the three-dimensional model.

19. The non-transitory computer readable storage medium of claim 17, the method further comprising:
receiving an input from a user selecting a three-dimensional shape to add to the three-dimensional model; and
in response to the input, adding the selected shape from the three-dimensional model.

20. The non-transitory computer readable storage medium of claim 17, wherein the three-dimensional model includes a plurality of three-dimensional shapes and is automatically generated from a cloud of points in a three-dimensional space.

21. The non-transitory computer readable storage medium of claim 20, wherein each point in the cloud of points is determined using LIDAR.

22. The non-transitory computer readable storage medium of claim 20, wherein each point in the cloud of points is determined using structure-from-motion.

23. The non-transitory computer readable storage medium of claim 17, the method further comprising:
receiving an input from a user selecting a position on a map;
sending a request to a server with the selected position; and
receiving a response to the request from the server, the response including the two-dimensional photographic image and the automatically generated three-dimensional model, wherein the three-dimensional model is geocoded in proximity to the position on the map.

24. (canceled)

25. The method of claim 1, further comprising,
when the first point in three-dimensional space and the second point in three-dimensional space are not located at a same position, performing, by the one or more computing devices, a non-linear optimization problem to solve for both the first and second set of camera parameters and an appropriate position in three-dimensional space for the feature of the three-dimensional model.

26. The system of claim 9, wherein the photogrammetry module performs a non-linear optimization problem to solve for both the first and second set of camera parameters and an appropriate position in three-dimensional space for the feature of the three-dimensional model when the first point in three-dimensional space and the second point in three-dimensional space are not located at a same position.

27. The non-transitory computer readable storage medium of claim 17, wherein the method further comprises, when the first point in three-dimensional space and the second point in three-dimensional space are not located at a same position, performing a non-linear optimization problem to solve for both the first and second set of camera parameters and an appropriate position in three-dimensional space for the feature of the three-dimensional model.
